(19) United States
(12) Patent Application Publication
(10) Pub. No.: US 2025/0200911 A1
(43) Pub. Date: Jun. 19, 2025

(54) System and Method for Producing a Representative Horizon

(71) Applicant: Vincent Loccisano, Wellesley, MA (US)

(72) Inventor: Vincent Loccisano, Wellesley, MA (US)

(21) Appl. No.: 19/063,925

(22) Filed: Feb. 26, 2025

(51) Int. Cl. G06T 19/00

(52) U.S. Cl. CPC G06T 19/006

(57) ABSTRACT

A system and method displaying a representative horizon through virtual and augmented reality technology mitigates the effects of motion sickness. In some embodiments, images creating a representative horizon are delivered through virtual-reality (VR) goggles. In other embodiments, representative horizon images are presented in integrated augmented-reality (AR) glasses. In yet other embodiments, a representative horizon is projected on vehicle windows and surfaces. Augmented-reality (AR) and virtual-reality (VR) systems are used to create a representative horizon while allowing a view of one's environment. These present a stable representative horizon that aligns with a person's vestibular system to minimize sensory disconnect.

### TECHNICAL FIELD

The present disclosure relates generally to augmented reality and virtual-reality equipment, and specifically to an application providing a virtual horizon line relative to the environment for mitigating the symptoms of motion sickness.

### BACKGROUND OF THE INVENTION

Motion sickness is a common ailment that arises from a discordance between the signals received by the brain from the visual system, the vestibular system, also known as the inner ear, and the proprioceptive system, also known as the body's sense of position and movement. This sensory mismatch is often experienced in vehicles including cars, boats, airplanes, amusement park rides, and spacecraft. The symptoms may include nausea, vomiting, dizziness, headache and fatigue. Severe cases exhibit symptoms including sweating, unsteadiness while feeling cold, clammy and disoriented. Further symptoms may include apathy, passivity and lack of concentration.

An absence of a steady, visual reference, such as a horizon line, has shown to worsen symptoms; this is one reason reading in a moving vehicle or shifting one's focus from the horizon worsens symptoms. In addition, women and the elderly tend to be more susceptible than others to motion sickness. Poor ventilation, odors, large meals and alcohol intake may also aggravate motion sickness.

Astronauts experience what is known as space motion sickness during their first days in microgravity, and again after return to earth. In the absence of gravity, relationships among signals from visual, skin, joint, muscle and vestibular receptors can be disrupted.

To mitigate motion sickness, a person may take an over-the-counter medication, such as an antihistamine or antiemetic, or use an accupressure band, or employ techniques such as focusing on a fixed point outside of the moving vehicle. While these methods may offer some temporary relief, they are limited in effectiveness. Medications may have undesirable side effects and behavioral techniques are not always effective, particularly when the external view is obstructed. In general, drug therapy is often inadequate and too slow-acting for meaningful relief of acute symptoms.

The horizon line, a readily perceived visual cue representing the boundary between earth and sky, is a stable reference point for the human brain to interpret motion and maintain equilibrium. When this visual reference is disrupted or unavailable, particularly together with conflicting vestibular input from the inner ear due to actual motion, the likelihood of motion sickness increases. This is the common scenario of a passenger experiencing motion sickness when they are inside the cabin and unable to view their surroundings.

The state of the art in motion-sickness mitigation offers various approaches, including pharmaceutical interventions, mechanical devices, and biofeedback techniques. Thse approaches however fail to address the fundamental issue of visual-vestibular conflict.

Some virtual-reality (VR) glasses have built-in accelerometers and gyroscopes, but these devices are not integrated with vehicle systems.

Modern vehicles have sensors and cameras that monitor aspects of the vehicle and its surroundings. Yaw-rate sensors, which measure a vehicle's rotation on its vertical axis, are used in stability-control systems. A steering-angle sensor measures the angle of a steering wheel. Accelerometers measure the vehicle's acceleration and deceleration. gyroscopes measure a vehicle's rate of rotation. A GPS module provides location data and can also provide elevation and direction data.

Automobile electronics, including computers, electrical cables, and software protocols, are together known as a controller-area network (CAN), or CANbus. A CAN is a vehicle's main computer system. Through the CANbus, data travels through the system to the many subsystems such as those controlling the engine, the transmission, doors, windows, and other subsystems. Each of these subsystems is controlled by an electronic control unit (ECU). Current vehicles may have fifty or more ECUs, each able to receive signals from sensors indicating, for example: acceleration at various angles; voltage; pressure; braking; vehicle roll and yaw; steering angle; temperature, and other variables. The CANbus routes signals from sensors to computers as communicated by each ECU. An ECU can monitor voltage used by a subsystem and communicate that information through the CANbus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development (such as adding passenger-controlled climate options) has become physically easier because each new feature can now be added by programming the new computer code into the CAN. Now, all vehicle features as well as vehicle diagnostics are controlled via CAN, which uses a standardized protocol called OBD-II. New features can be integrated into a vehicle by developing and uploading an algorithm into the vehicle's CAN.

There remains a need for a more effective and readily accessible solution for mitigating motion sickness that directly addresses the underlying cause of visual-vestibular conflict by providing a consistent and stable visual reference, regardless of a person's surroundings.

### SUMMARY OF THE INVENTION

A system and method displays a set of illuminated pixels that creates a representative horizon for the purpose of mitigating motion sickness while in a moving vehicle. By following, imitating or overlaying a generated horizon onto a viewable surface, such as that of eyewear lens, or on the screen of an electronic device, the system and method aligns with a person's vestibular system to minimize sensory disconnect, mitigating motion sickness.

A central processing unit, also referred to as a computer, storing an application, receives information from sensors to derive a duplicate or calculated representative horizon to display. A duplicate-representative horizon is overlaid on an actual horizon. A duplicate-representative horizon may be projected on a windshield of a vehicle such as a car, truck, boat or aircraft or any environment where the actual horizon is visible. A calculated-representative horizon is a level line displayed at eye level that maintains a level orientation as the projecting apparatus and environment move. A duplicate-representative horizon or a calculated-representative horizon may be displayed on eyewear such as VR goggles or AR glasses, or through a projector. A calculated-representative horizon is effective in an environment without windows or with few or poorly visible windows, such as a cabin on a boat or the interior of an airplane.

Using reference points derived from sensors, the application calculates a representative horizon. It may use sensor data from cameras, speed sensors, accelerometers, gyroscopes, yaw-rate sensors, vehicle-roll and yaw sensors, steering-angle and GPS systems, and the like. Data from these sensors denote location, direction and altitude, as well as velocity, acceleration, pitch, roll and yaw of a vehicle. An algorithm receives data from these sensors to calculate a representative horizon. In an environment with a view of the actual horizon, a duplicate-representative horizon is aligned using camera data to duplicate and overlay the actual horizon. A duplicate-representative horizon may be displayed through a projector on vehicle windows, or through AR glasses or VR goggles that also display environmental imagery. In an environment with poorly visible or no windows, a calculated horizon is derived from the various sensors, and maintained at a level orientation.

In some embodiments, the sensors are part of a conventional electronic device such as a vehicle electronic system. A representative horizon in VR goggles or AR glasses may interface with sensors embedded in the electronic device, or may interface with auxiliary sensors. A representative horizon may be projected by a vehicle heads-up display or other projector configured to project images on vehicle surfaces and windows. Augmented-reality (AR) systems are used to create a representative horizon while allowing a view of one's environment. When connected with vehicle electronics, the representative horizon may be coupled with a vehicle navigation system to anticipate changes in direction, altitude, angle and the like so that the virtual horizon is synced with the movement of the vehicle.

The term vehicle may refer to a land vehicle, water vehicle or aircraft. In some embodiments the system and method interfaces with conventional sensors in vehicles including accelerometers, gyroscopes, velocity sensors, wheel-speed sensors, altitude sensors, and GPS.

In some embodiments, audio references, such as ocean waves or engine ‘hum, mimic environmental background sounds to augment the VR or AR experience.

### BRIEF DESCRIPTION OF DRAWINGS

FIG. 1 is an illustration of an embodiment 100 used with VR goggles.

FIG. 2 shows an iteration of the embodiment 200 used with augmented-reality (AR) glasses.

FIG. 3 shows an iteration of the embodiment 300 projected on vehicle windows.

FIG. 4 is a diagram depicting a method 400 of the embodiment.

### DETAILED DESCRIPTION

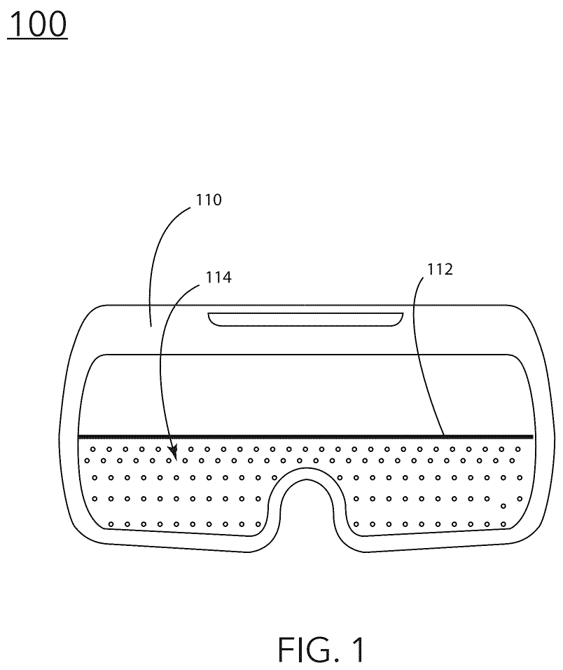

FIG. 1 shows an example embodiment 100 used with a virtual-reality headset. A VR headset 110 is controlled by embedded software or may be wirelessly connected to a personal electronic device that projects an image 114 on the VR screen. A representative horizon 112 is integrated with the image in the illustration. The image illustrates a gradation 114 meeting the representative horizon 112. Various gradations, colors or actual images of scenery may be used, or a representative horizon may be the only image displayed. In one embodiment, data from accelerometers and gyroscopes in the VR goggles or in a personal electronic device are received in a processor storing an application that evaluates the data to hold the representative horizon 112 and related imagery 114 in a relative position to the actual horizon. This is referred to as a duplicate-representative horizon. The system and method minimizes sensory disconnect by aligning the representative horizon 112 with the user's vestibular system as the user moves. In another embodiment, data from accelerometers and gyroscopes in the VR goggles, or in a personal electronic device, is received by a processor storing an application that calculates the data to hold the representative horizon 112 and related imagery 114 in a level orientation, independent of an actual horizon, as the user moves.

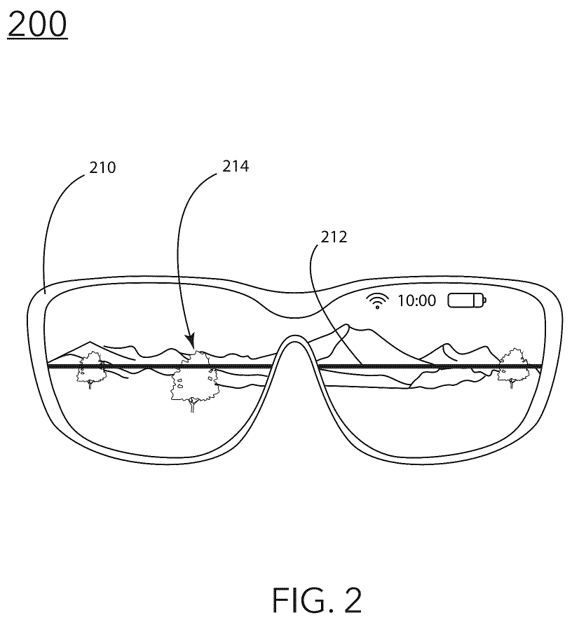

FIG. 2 shows an iteration of the embodiment 200 depicting a pair of AR glasses 210 that enable viewing an actual environment 214 with an overlaid, projected duplicate-representative horizon 212. While an actual horizon line may be obscured, the representative horizon 212 is always visible.

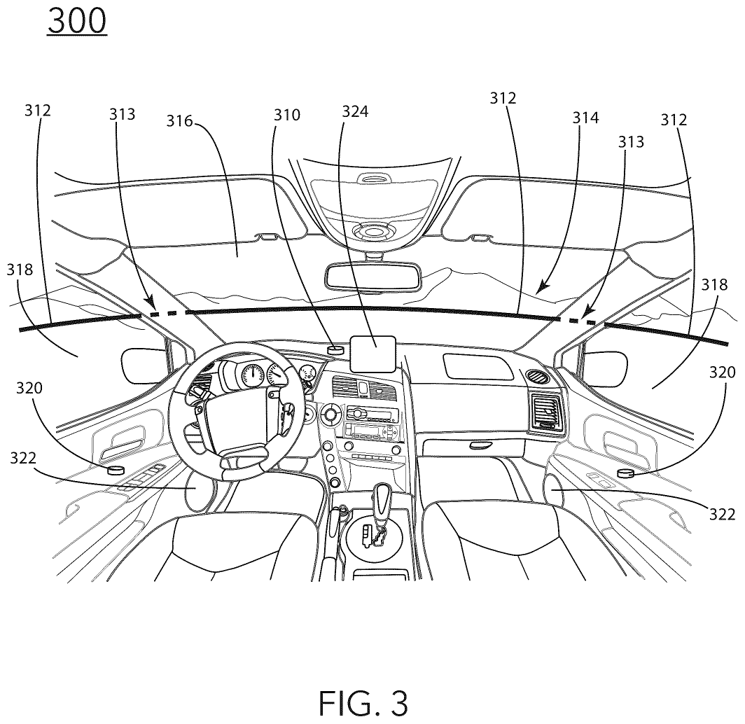

FIG. 3 shows an iteration of the embodiment 300 of a windscreen projector 310 projecting a representative horizon 312 on the windscreen 316. Side-window projectors 320 project the representative horizon 312 onto side windows 318. The windscreen projector 310 and side-window projectors 320 may be configured to project a horizon line (represented by dashed lines 313) on parts of the vehicle that may obstruct the user's view of the representative horizon 312 by projecting on obstacles. In this example embodiment the representative horizon 312 is derived of the actual horizon 314 and duplicates the actual horizon accounting for obstacles, such as mountainous terrain. Vehicle speakers 322 play sounds to augment the experience and may include white noise, ocean-wave sounds or noise-cancellation sounds. In some embodiments, an application for controlling the representative horizon 312 imagery is controlled by the vehicle's digital-control unit 324. One skilled in the art is familiar with wireless connectivity between a personal electronic device storing an application with a vehicle's digital-control units 324.

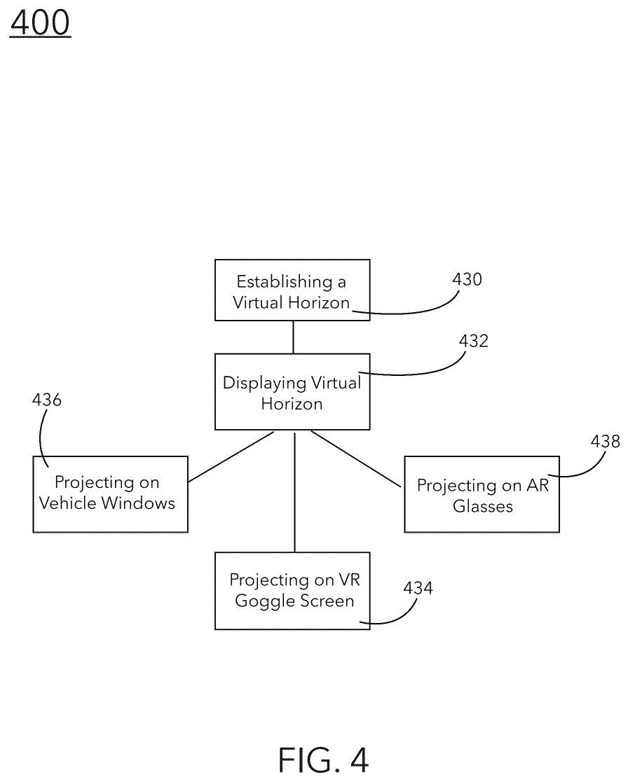

FIG. 4 is a diagram of a method 400 for using the embodiment and iterations thereof. The method begins by establishing a representative horizon 430 and continues by displaying it 432.

If the representative horizon is displayed on the screen of a pair of VR goggles as used in iteration 100, establishing a horizon 430 may involve calibrating an accelerometer and gyroscope in the VR goggles while the user holds their head level. A representative horizon and related imagery may then be projected on the VR screen 434. As the user moves, or as the vehicle they are in moves, the image is held in place relative to the goggles' calibrated accelerometer and gyroscope.

The method may alternatively continue by projecting the representative horizon 432 on the lenses of a pair of AR glasses 438 as in iteration 200. In this iteration, the system and method scans the environment, determines the actual horizon, and establishes a representative horizon 430.

The method may alternatively continue by projecting the representative horizon 432 on the windscreen and windows of a vehicle 436. This variation also uses AR; the environment is scanned to establish a representative horizon 430 by referencing the actual horizon.

1. A system for alleviating motion sickness comprising:
a central processor storing an application; and
an interface between the application and a conventional electronic device having at least one display; and
a representative horizon graphic calculated by the application and configured to be displayed on the at least one display of the conventional electronic device.

2. The system of claim 1 wherein:
the conventional electronic device is a personal electronic device.

3. The system of claim 2 wherein:
the conventional electronic device is a mobile phone; wherein
the representative horizon line is associated with sensor data from sensors in the mobile phone.

4. The system of claim 3 wherein:
sensors in the mobile phone include at least one gyroscope, at least one accelerometer and a GPS system.

5. The system of claim 2 wherein:
the conventional electronic device is a smart-watch.

6. The system of claim 1 wherein:
the conventional electronic device is a vehicle electronic system receiving vehicle sensor data; and
the at least one display is a projector configured to project an image of the representative horizon on vehicle window glass.

7. The system of claim 6 wherein:
the projector is configured to project an image of the representative horizon on opaque vehicle surfaces.

8. The system of claim 6 wherein:
vehicle sensor data includes navigation, direction, velocity and acceleration data.

9. The system of claim 1 wherein:
the at least one display is a liquid crystal display screen.

10. The system of claim 1 wherein:
the at least one display is engaged with virtual reality hardware.

11. The system of claim 10 wherein:
the representative horizon is displayed on an otherwise blank screen.

12. The system of claim 10 wherein:
the representative horizon is overlaid with additional digital screen data.

13. The system of claim 1 wherein:
the at least one display is engaged with augmented reality hardware.

14. The system of claim 13 wherein:
the representative horizon is overlayed with the surrounding environment.

15. The system of claim 1 wherein:
the at least one display is engaged with video game hardware.

16. The system of claim 1 wherein:
the at least one display is engaged with semi-autonomous vehicle control hardware.

17. The system of claim 1 wherein:
sensors in the conventional electronic device include at least one gyroscope; wherein
the representative horizon graphic is maintained in a stationary position in response to rotation and tilt measured by the gyroscope.

18. The system of claim 1 wherein:
sensors in the conventional electronic device include at least one accelerometer; wherein
the representative horizon graphic is maintained in a stationary position in response to velocity and acceleration measured by the accelerometer.

19. The system of claim 1 wherein:
sensors in the conventional electronic device include a GPS system; wherein
the representative horizon graphic is maintained in a stationary position in response to location, elevation, direction and speed data measured by the GPS system.

20. A method for using the system of claim 1, the method comprising:
establishing a representative horizon; and
displaying the representative horizon; and
projecting the representative horizon.
